(19) United States
(12) Patent Application Publication
(10) Pub. No.: US 2026/0334731 A1
(43) Pub. Date: Oct. 29, 2026

(54) BLENDER

(71) Applicant: NUC Electronics Co., Ltd., Daegu (KR)

(72) Inventor: Jong Boo KIM, Daegu (KR)

(21) Appl. No.: 19/720,433

(22) Filed: Jun. 25, 2026

Related U.S. Application Data
(63) Continuation of application No. PCT/KR2025/007499, filed on May 30, 2025.

(30) Foreign Application Priority Data
Jun. 3, 2024 (KR) 20-2024-0000971

(51) Int. Cl. A47J 43/046; A47J 43/07

(52) U.S. Cl. CPC A47J 43/0465; A47J 43/0761

(57) ABSTRACT

A magnetic blender with a finger pinching prevention structure is disclosed. The magnetic blender is a processing device utilizing magnetic force to rotate blades without requiring a separate drive shaft within a main body and a container and can prevent finger pinching accidents that may occur due to strong magnetic force during coupling of the container to the main body.

### BACKGROUND

### Technical Field

The present disclosure relates to a magnetic blender, which is a processing device utilizing magnetic force to rotate blades without requiring a separate drive shaft within a main body and a container.

### Description of the Related Art

Mixing and blending devices, such as blenders and mixers used for preparation of food and beverages, are common in general household applications. Typically, these devices include a main container and a lid covering an open end of the main container and are configured to hermetically seal the container containing ingredients to be processed. The container is often used to hold the processed food or beverage. Food ingredients are generally processed using a blade assembly attached to an upper portion of a rotary shaft.

A major drawback of typical food processing devices is that a container in which food ingredients are to be processed is mechanically attached to a housing by utilizing various holders and mechanical couplings.

Thus, typical blenders relying on mechanical couplings produce significant noise during operation. Moreover, when rotation of a blade is restricted or stalled by food ingredients during blending, such blenders lack the ability to easily dislodge such obstructions, leading to damage to an agitator motor.

To address these issues, Korean Patent Laid-open Publication No. 10-2019-7015821 (published on August 07, 2019) and the like have proposed a food and beverage processing apparatus that rotates a blade using magnetic force by disposing magnetic coupling components driven by magnetic force in a base and a lid of a container, respectively.

However, this processing apparatus has a problem in that, when a user holds the container and couples the same to the base, their fingers can be easily caught in a gap between a lower end of the container and an upper end of the base due to strong magnetic force during assembly, resulting in a finger pinching injury.

The related art is disclosed in Korean Patent Laid-open Publication No. 10-2019-7015821 (published on Aug. 07, 2019).

BRIEF SUMMARY

### Technical Problem

It is one aspect of the present invention to provide a magnetic blender with a finger pinching prevention structure, which features a side wall protruding upward from a main body, thereby preventing finger entrapment during coupling of a container to a main body while guiding movement of the container to a designated position.

It is another aspect of the present invention to provide a magnetic blender with a finger pinching prevention structure, which features a side wall protruding upward from a main body to support a user's palm during coupling or decoupling of the container to or from the main body, thereby ensuring stable and easy coupling and decoupling of the container.

### Technical Solution

In accordance with one aspect of the present invention, a magnetic blender with a finger pinching prevention structure includes: a main body including a motor and a side wall protruding upward; a container detachably disposed at an upper portion of the main body and having an opening at an upper end thereof; and a lid configured to close or open the opening of the container, wherein the main body includes: a first magnetic assembly driven by the motor; and a seating portion on which the lid is seated upon coupling of the lid to the main body, the lid includes: a support surface formed at a lower portion thereof to be seated on and supported by the seating portion of the main body; a second magnetic assembly magnetically couplable to the first magnetic assembly of the main body; and a blade connected to the second magnetic assembly, and wherein, when the support surface of the lid is coupled to the seating portion of the main body by magnetic force, the side wall prevents a user's finger from being pinched between the lid and the main body.

The side wall may have an inclined inner surface gradually sloping toward a central axis thereof from an upper end thereof to a lower end thereof; and an inclined outer surface gradually sloping outward from the lower end thereof to the upper end thereof.

The side wall may have an edge formed between the inclined inner surface and the inclined outer surface.

The container may include an insertion protrusion formed on one end surface thereof and inserted into and coupled to the lid, and the lid may include an insertion groove formed at one end surface thereof and allowing the insertion protrusion of the container to be coupled thereto; and the container and the lid may include respective coupling portions such that the container and the lid are screwed together upon coupling therebetween.

The seating portion of the main body may be formed with a zigzag-shaped protrusion having a partial slope to allow the support surface of the lid to be accurately seated thereon, and the support surface of the lid may be formed with a zigzag-shaped protrusion having a partial slope corresponding to that of the protrusion of the seating portion such that the main body and the lid are placed in designated positions by the slopes of the protrusions upon coupling therebetween.

The seating portion of the main body may be formed with at least one coupling safety device configured to detect the presence of the lid.

The side wall may be spaced apart from the main body by a predetermined distance to facilitate coupling between the seating portion and the support surface.

The side wall may be formed in an arc shape with a wide top and a narrow bottom.

### Advantageous Effects

Embodiments of the present invention provide a magnetic blender with a finger pinching prevention structure, which features a side wall protruding upward from a main body, thereby preventing pinching of a finger upon coupling of a container to the main body.

In addition, with the side wall protruding upward from the main body, the magnetic blender according to an embodiment of the present invention can guide the container to be moved to a designated position upon coupling of the container to the main body.

Furthermore, with the side wall protruding upward from the main body, the magnetic blender according to the present invention allows a user's palm to be properly supported upon coupling or decoupling the container to or from the main body, thereby ensuring stable and effortless coupling and separation of the container.

### BRIEF DESCRIPTION OF THE SEVERAL VIEWS OF THE DRAWINGS

The accompanying drawings are intended to aid in understanding of the present invention and provide exemplary embodiments alongside the detailed description. However, it should be understood that the technical scope of the invention is not limited to any specific drawing, and individual features disclosed across different drawings may be combined to constitute new embodiments.

FIG. 1 is a perspective view of a magnetic blender according to one embodiment of the present invention.

FIG. 2 is an exploded top perspective view of the magnetic blender.

FIG. 3 is an exploded bottom perspective view of the magnetic blender.

FIG. 4 is a front view of the magnetic blender.

FIG. 5 is a side view of the magnetic blender.

FIG. 6 is a rear view of the magnetic blender.

FIG. 7 is a plan view of a main body of the magnetic blender according to one embodiment of the present invention.

FIG. 8 is a bottom view of a lid of the magnetic blender according to one embodiment of the present invention.

FIG. 9 is a cross-sectional view of FIG. 1.

FIG. 10 is a cross-sectional view of the magnetic blender, illustrating coupling or decoupling of the lid to or from the main body.

FIG. 11 is a view illustrating a configuration of the main body of the magnetic blender according to one embodiment of the present invention.

FIG. 12 is a view illustrating a configuration of the lid of the magnetic blender according to one embodiment of the present invention.

### DETAILED DESCRIPTION

Hereinafter, exemplary embodiments of the present invention will be described in detail with reference to the accompanying drawings.

The above and other aspects, features, and advantages of the present invention will become apparent from the detailed description of the following embodiments in conjunction with the accompanying drawings.

However, it should be understood that the present invention is not limited to the following embodiments and may be embodied in different ways, and that the embodiments are provided for complete disclosure and a thorough understanding of the present invention by those skilled in the art. The scope of the present invention is defined only by the claims.

Descriptions of known functions and constructions which may unnecessarily obscure the subject matter of the present invention will be omitted.

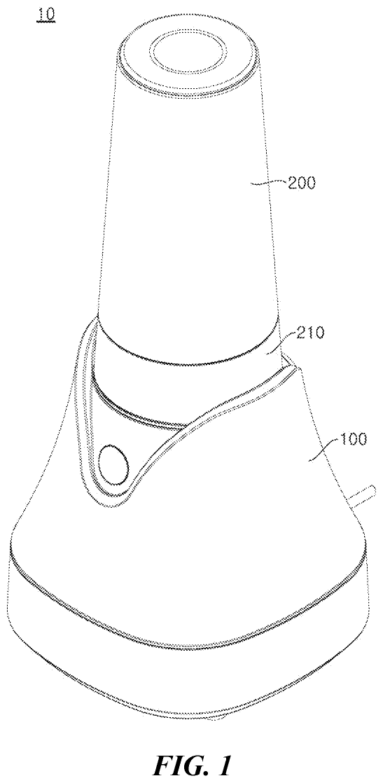

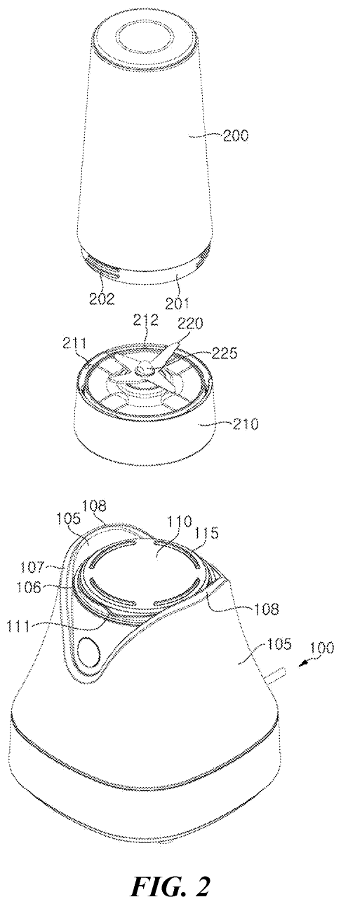

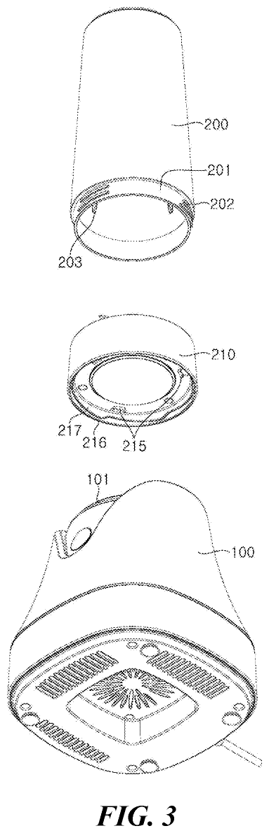

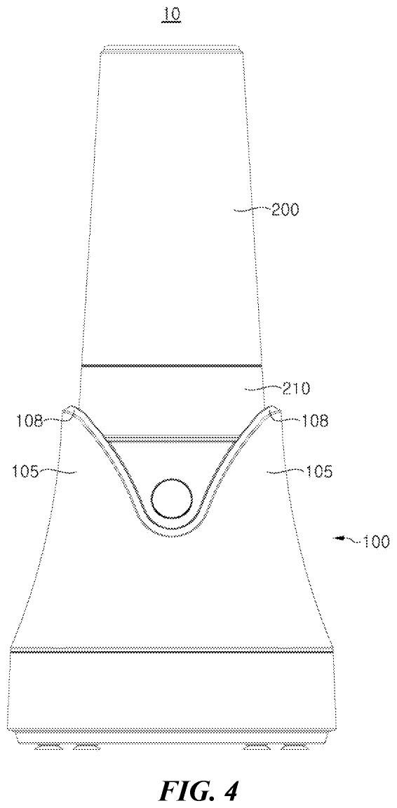

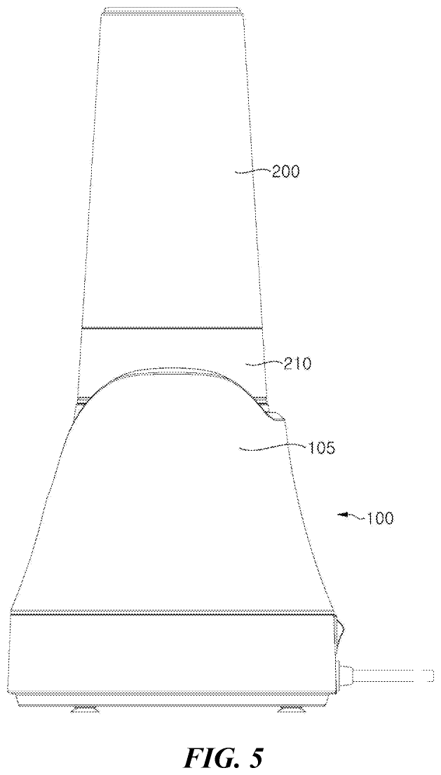

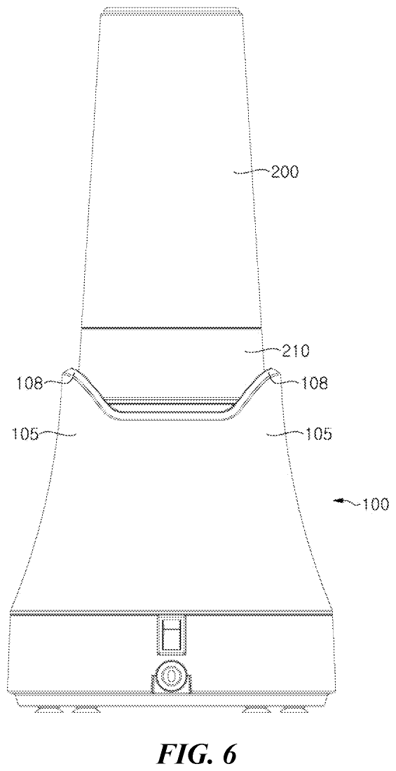

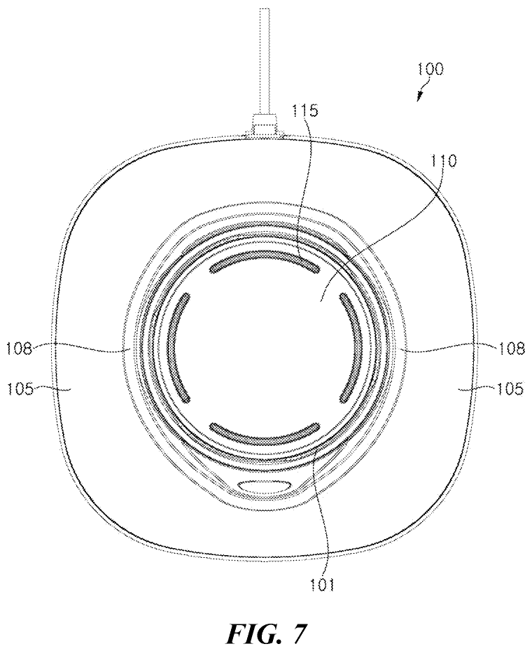

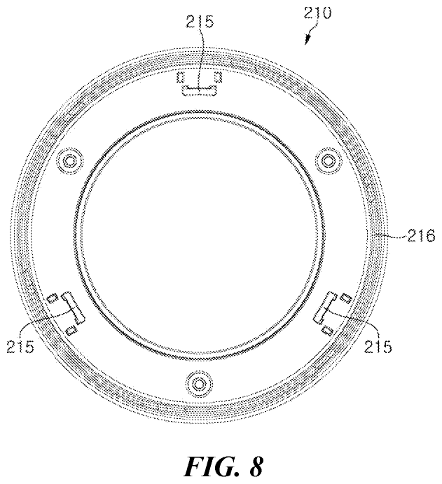

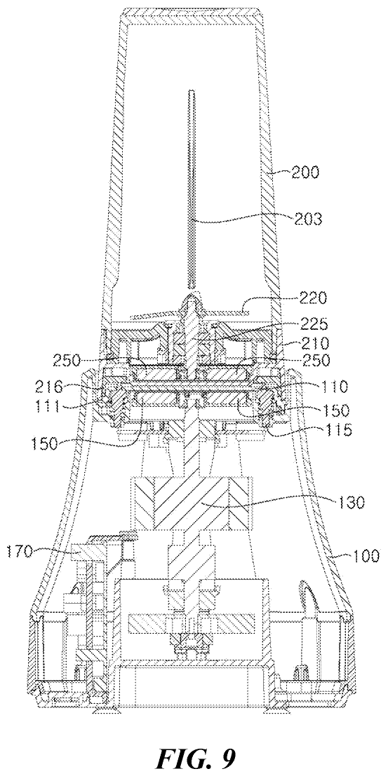

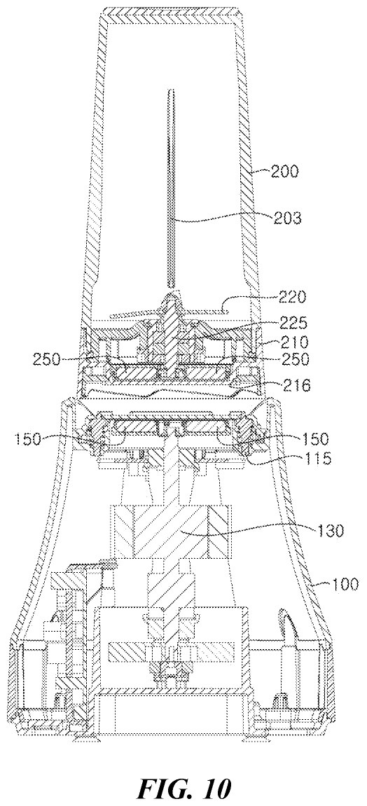

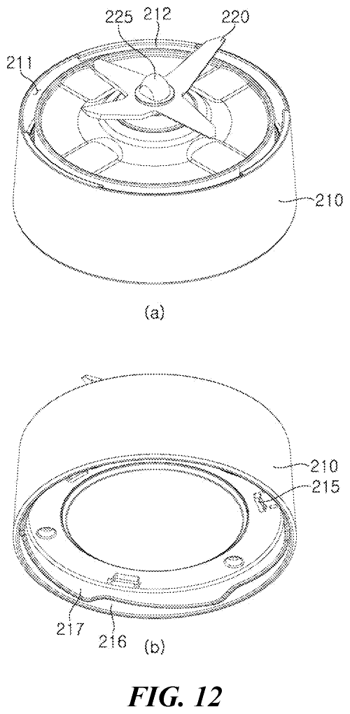

Referring to FIG. 1 to FIG. 12, a magnetic blender with a finger pinching prevention structure according to an embodiment of the present invention includes a main body 100, a container 200, and a lid 210, wherein the main body 100 includes a motor 130 and a magnetic assembly connected to the motor 130, and the magnetic assembly may include at least one magnet.

In addition, the main body may include a controller 170 configured to control operation of the blender.

More specifically, referring to FIG. 1 to FIG. 12, the main body 100 may include a motor and a side wall 105 protruding upward.

The container 200 is detachably disposed at an upper portion of the main body and has an opening at an upper end thereof.

The lid 210 is configured to close or open the opening of the container 200.

In addition, the main body 100 may include: a first magnetic assembly 150 driven by the motor 130; and a seating portion 110 allowing the lid 210 to be seated thereon upon coupling of the main body 100 to the lid 210.

In addition, the lid 210 may include: a support surface 216 formed at a lower portion thereof to be seated on and supported by the seating portion 110; and a second magnetic assembly 250 configured to be magnetically coupled to the first magnetic assembly 150 of the main body 100.

In addition, the lid 210 may include a blade 220 connected to the second magnetic assembly 250.

The side wall 105 of the main body serves to prevent finger pinching that may occur when the support surface 216 of the lid 210 is coupled to the seating portion 110 of the main body 100 by strong magnetic attraction between the respective magnetic assemblies thereof.

In addition, the container 200 may include an insertion protrusion 201 formed on one end surface thereof to be inserted into and coupled to the lid 210, and the lid 210 may include an insertion groove 211 formed on one end surface thereof and allowing the insertion protrusion 201 of the container 200 to be coupled thereto. Here, the container 200 and the lid 210 may include respective coupling portions 202, 212 to be screwed together upon coupling therebetween.

That is, the container 200 may include a coupling portion 202 formed at the insertion protrusion 201, and the lid 210 may include a coupling portion 212 formed at a portion thereof, into which the insertion protrusion 201 is inserted, to be coupled to the coupling portion 202 of the container 200.

In addition, the seating portion 110 of the main body 100 may include a zigzag-shaped protrusion 111 having a partial slope to allow the support surface 216 of the lid 210 to be accurately seated on the seating portion 110, and the support surface 216 of the lid 210 may include a zigzag-shaped protrusion 217 having a partial slope corresponding to that of the protrusion 111 of the seating portion 110, whereby the main body 100 and the lid 210 can be guided into designated positions through the slopes of the protrusions 111, 217 upon coupling therebetween.

In addition, the seating portion 110 of the main body 100 may be formed with at least one coupling safety device 115 configured to recognize the presence of the lid 210.

That is, the coupling safety device 115 may detect the presence of at least one contact portion 215 provided at a lower portion of the lid 210 to check proper coupling of the lid 210 to the main body so as to detect the presence of the container 200 coupled to the lid 210.

In one embodiment, the coupling safety device 115 may be of a micro-switch sensor type or a Hall sensor type.

Accordingly, the motor is not operated unless the presence of the container 200 on the seating portion 110 of the main body 100 is detected.

As a result, driving force of the motor is transmitted to the blade to rotate the blade only when the second magnetic assembly 250 of the lid 210 and the first magnetic assembly 150 of the main body 100 are securely coupled to each other by magnetic attraction therebetween.

That is, in one embodiment, the support surface 216 of the lid 210 may be coupled to the seating portion 110 of the main body 100 by magnetic attraction between the first magnetic assembly 150 of the main body 100 and the second magnetic assembly 250 of the lid 210, which includes at least one magnet.

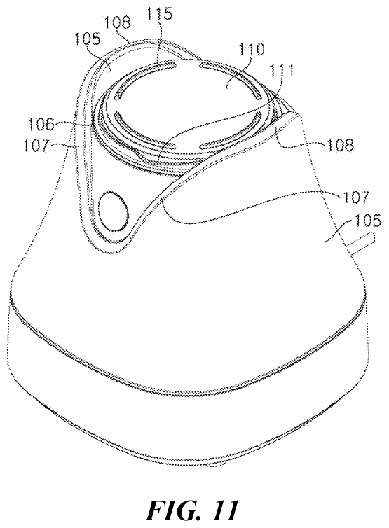

In addition, referring to FIG. 11, in the magnetic blender with a finger pinching prevention structure according to an embodiment of the present invention, the side wall 105 of the main body 100 may include an inclined inner surface 106 gradually sloping toward a central axis thereof from an upper end thereof to a lower end thereof; and an inclined outer surface 107 gradually sloping outward from the lower end thereof to the upper end thereof.

When the container 200 is placed on the inclined inner surface 106 of the side wall 105, rather than being placed at a designated position on the main body 100, the slope of the inclined inner surface 106 serves to guide the container 200 to be moved to the designated position by magnetic attraction between the first magnetic assembly and the second magnetic assembly.

In addition, the side wall 105 may include an edge 108 formed between the inclined inner surface 106 and the inclined outer surface 107.

That is, when a user holds the container 200 or the lid 210 and couples the same to the main body 100, the side wall 105 serves as a barrier to prevent their hand from entering a space between the seating portion 110 and the support surface 216.

With the side wall 105 protruding upward from the main body 100, the blender according to an embodiment of the present invention can prevent pinching of a user's finger upon coupling of the lid to the main body.

In addition, the side wall 105 is spaced apart from the main body by a predetermined distance to facilitate coupling between the seating portion 110 and the support surface 216.

That is, even when a user's finger enters a space between the seating portion 110 and the side wall 105, the side wall 105 can prevent pinching of the finger by allowing the finger to be pushed away from the inclined inner surface 106 toward the edge 108 or the inclined outer surface 107 to block entry of the finger into the space.

If there is no clearance between the side wall 105 and the main body 100, a user's finger can be caught in a narrow gap between the main body 100 and the side wall 105 and coupling between the support surface 216 and the seating portion 110 can be achieved only in a vertical direction due to a limited free space for coupling the support surface 216 to the seating portion 110, making it difficult to couple and separate the lid 210 to and from the main body 100.

Accordingly, the clearance between the side wall 105 and the main body 100 serves to ensure easy coupling between the seating portion 110 and the support surface 216.

In addition, the side wall 105 may be formed in an arc shape that is gradually widened toward an upper end thereof.

That is, the side wall 105 may be formed in an arc shape with a wide top and a narrow bottom.

As a result, upon coupling of the support surface 216 to the seating portion 110, entry of the support surface 216 can be achieved in multiple directions without being limited to a specific direction, thereby facilitating coupling between the lid 210 and the main body 100.

In addition, when the support surface 216 is not properly coupled to the seating portion 110, the inclined inner surface 106 of the side wall or the arc-shaped inclined surface of the side wall allows the support surface 216 to be moved to a designated position.

That is, the side wall may serve to guide the first magnetic assembly 150 of the main body and at least one magnet of the lid 210 to be placed at designated positions by magnetic attraction therebetween.

However, it should be understood that the side wall 105 may be formed in various other shapes, without being limited to the arc shape.

In addition, the side wall 105 may serve as a supporting structure to facilitate coupling and separation of the container 200.

In particular, upon coupling of the support surface 216 to the seating portion 110, the side wall 105 provides a surface to support a user's palm while preventing pinching of the user's finger and, upon separation of the support surface 216 from the seating portion 110, the side wall 105 serves as a fulcrum supporting the user's palm, thereby allowing the user to easily separate the support surface from the seating portion based on the principle of leverage.

This feature allows the user's palm to be properly supported during coupling or separation of the container 200 to or from the main body 100, thereby ensuring stable and effortless coupling and separation of the container 200.

Here, to facilitate separation of the container, the principle of leverage needs to be utilized (by pulling the container in a lateral direction while applying downward pressure to the main body). Unlike typical magnetic blenders that require two-handed operation, that is, holding a main body with one hand while pulling a container with the other hand, the blender according to an embodiment of the present invention allows a user to easily separate the container with one hand by utilizing the side wall as a fulcrum supporting the hand.

Accordingly, with the side wall protruding upward from the main body, the magnetic blender according to an embodiment of the present invention can prevent pinching of a finger upon coupling of the container to the main body.

In addition, with the side wall protruding upward from the main body, the magnetic blender according to an embodiment of the present invention can guide the container to be moved to a designated position upon coupling of the container to the main body.

Furthermore, with the side wall protruding upward from the main body, the magnetic blender according to an embodiment of the present invention allows a user's palm to be properly supported upon coupling or separation of the container to or from the main body, thereby ensuring stable and effortless coupling and separation of the container.

Although some embodiments have been described herein, it should be understood that various modifications, changes, and alterations can be made by those skilled in the art without departing from the spirit and scope of the invention.

Therefore, the scope of the present invention should be defined by the appended claims and equivalents thereto, without being limited to the foregoing embodiments.

That is, it should be understood that the foregoing embodiments are provided for illustration only and are not to be in any way construed as limiting the present invention, the scope of the invention is limited by the accompanying claims rather than by the detailed description, and the accompanying claims and equivalents thereto are intended to cover such modifications as would fall within the scope and spirit of the invention. In other words, in the following claims, the terms used should not be construed to limit the claims to the specific embodiments disclosed in the specification and the claims, but should be construed to include all possible embodiments along with the full scope of equivalents to which such claims are entitled.

This application is a continuation of International Application No. PCT/KR 2025/007499, filed May 30, 2025, which claims priority to Korean Patent Application No. 20-2024-0000971, filed Jun. 3, 2024, the entire disclosures of which are herein incorporated by reference for all purposes.

1. A magnetic blender with a finger pinching prevention structure, the blender comprising:
a main body including a motor and a side wall protruding upward and having an inner inclined surface gradually inclined toward a central axis from an upper end thereof to a lower end thereof;
a container detachably disposed at an upper portion of the main body and having an opening at an upper end thereof; and
a lid configured to close or open the opening of the container,
wherein the main body comprises: a first magnetic assembly driven by the motor; and a seating portion on which the lid is seated upon coupling of the lid to the main body,
the lid comprises: a support surface formed at a lower portion thereof to be seated on and supported by the seating portion of the main body; a second magnetic assembly magnetically couplable to the first magnetic assembly of the main body; and a blade connected to the second magnetic assembly, and
wherein, when the support surface of the lid is coupled to the seating portion of the main body by magnetic force, the side wall prevents a user's finger from being pinched between the lid and the main body.

2-8. (canceled)

9. A magnetic blender with a finger pinching prevention structure, the blender comprising:
a main body including a motor and a side wall protruding upward and spaced apart from the main body by a predetermined distance;
a container disposed above the main body to be detachable therefrom and having an opening at an upper end thereof; and
a lid configured to close or open the opening of the container,
wherein the main body comprises: a first magnetic assembly driven by the motor; and a seating portion on which the lid is seated upon coupling of the lid to the main body,
wherein the lid comprises: a support surface formed at a lower portion thereof to be seated on and supported by the seating portion of the main body; a second magnetic assembly magnetically couplable to the first magnetic assembly of the main body; and a blade connected to the second magnetic assembly, and
wherein, upon coupling of the support surface of the lid to the seating portion of the main body by magnetic force, the side wall is spaced apart from the main body by a predetermined distance to facilitate coupling between the seating portion and the support surface, thereby preventing finger pinching.
